(19) United States
(12) Patent Application Publication
(10) Pub. No.: US 2021/0010170 A1
(43) Pub. Date: Jan. 14, 2021

(54) TRIBLEND COTTON FABRIC

(71) Applicant: K. G. Denim Limited, Coimbatore (IN)

(72) Inventors: Vijayaragavan RANGANATHAN, Coimbatore (IN); Neelamegam Krishnamoorthy JANARDHANAN, Coimbatore (IN); Sundaram RAJESH, Coimbatore (IN)

(73) Assignee: K. G. Denim Limited, Coimbatore (IN)

(21) Appl. No.: 16/509,058

(22) Filed: Jul. 11, 2019

(51) Int. Cl. D03D 13/00; D03D 15/00; D03D 1/00; D02G 3/04

(52) U.S. Cl. CPC D03D 13/004; D03D 15/00; D03D 1/0017; B32B 5/26; D10B 2331/04; D10B 2201/02; D02G 3/04

(57) ABSTRACT

A woven textile fabric that is soft, comfortable and durable includes warp yarns and weft yarns, wherein the warp yarns include cotton and at least one fiber other than cotton, the weft yarns comprise polyester, the fabric comprises from 44 to 300 ends per inch warp yarn and from 24 to 1800 picks per inch weft yarn. The warp count ranges from 2 s count to 170 s count and the weft count ranges from 7 denier to 150 denier. The fabric is particularly useful as a bed linen.

### BACKGROUND OF THE INVENTION

### 1. Field of the Invention

The invention relates generally to a woven textile fabric and more particularly to a woven textile fabric having a composition including warp yarns and weft yarns wherein the warp yarns comprise cotton and at least one fiber other than cotton and the weft yarns comprise polyester. The woven textile fabric of the invention may be particularly useful as a bed linen.

### 2. Description of the Related Art

A good woven textile fabric, such as bed linens or apparel, has a host of characteristics that make it appealing. For example, bed linens such as sheets should feel smooth, have lasting softness, absorb moisture, be breathable, and be durable.

Today's over-sized mattresses require non-traditional sheets. Most sheets on the market pop off the corners of an over-sized mattress or fit too tight, creating a drum effect. Sheets that fit too tightly completely firm up the feel of the mattress and thus are uncomfortable.

Another problem with most traditional sheets and bed linens is that they are not allergen-free. A healthy and comfortable sleep requires sheets that are allergen free.

Another problem associated with fabrics used in bed linens is the incorporation of functional properties, such as absorbency and after wash retention.

In view of the above, the object of the invention is to provide a woven textile fabric and method of making the same that possesses the excellent characteristics discussed above (e.g., smooth feel, lasting softness, moisture absorption, breathability, appropriate fit) and is durable enough to have longevity, particularly in view of being subjected to frequent machine laundering. The challenge is achieving the characteristics of comfort as described above and at the same time producing a durable fabric. Many of the fibers that impart smoothness, softness and moisture absorption to a fabric are not durable. Conversely, many of the fibers that impart durability to the fabric are not smooth, soft and moisture absorbent. The principal object of the invention, therefore, is to create a woven textile fabric that simultaneously possesses all the properties described above. Other objects will be apparent from the detailed description of the invention which follows.

### SUMMARY OF THE INVENTION

Broadly stated, the objects of the invention are realized, according to one aspect of the invention, by producing a woven textile fabric comprising warp yarns and weft yarns, wherein the warp yarns comprise cotton and at least one fiber other than cotton, the weft yarns comprise polyester, the fabric comprises from 44 to 300 ends per inch warp yarns and from 24 to 1800 picks per inch weft yarns.

The at least one fiber other than cotton may include, for example, a regenerated cellulosic fiber such as lyocell (e.g., Tencel™), viscose, or modal. It may also include a natural or synthetic fiber (e.g., polyester).

According to one aspect of the invention, the at least one fiber other than cotton comprises a regenerated cellulosic fiber. In another aspect, the regenerated cellulosic fiber is lyocell.

According to one aspect of the invention, the weft yarns in the fabric comprise untwisted, multiple filament texturized yarns.

In another aspect, the weft yarns further comprise untwisted, single filament texturized yarn.

According to one embodiment of the invention, the regenerated cellulosic fiber is present in an amount ranging from about 5% to about 10%, the cotton is present in an amount greater than 51%, and the polyester is present in an amount ranging from about 5% to about 40%. According to another embodiment, the regenerated cellulosic fiber is present in an amount of about 7%, the cotton is present in an amount of about 64%, and the polyester is present in an amount of about 29%.

According to one aspect of the invention, the weave of the fabric is a 1/1 plain weave, a 2/1 twill weave, a 4/1 satin weave, a Dobby weave, a Jacquard weave, any reverse or derivative of the same, or any combination of the same.

The woven textile fabric may be used as bed linen. The bed linen may be, for example, a pillow cover, a flat sheet, a bottom sheet, a fitted sheet, a box sheet, a duvet cover, a sham, a quilt, a comforter, a blanket a throw, a pillow of any type (e.g., a decorative pillow), or a cushion.

The thread count of the woven textile fabric according to an aspect of the invention may range from about 132 to about 2000. In another embodiment, the warp count ranges from 2 s count to 170 s count and the weft count ranges from 6 denier to 150 denier.

According to one aspect of the invention, the minimum amount of warp yarns in the woven textile fabric is 51% and the maximum amount of weft yarns is 49%. The weft yarns may include multiple filament texturized polyester yarns having from 8 to 108 filaments each.

In one aspect of the invention, the untwisted, multiple filament texturized yarns are inserted into the fabric from multiple weft yarn supply packages in a single pick insertion.

In another aspect, the untwisted, multiple filament texturized yarns are located adjacent to one another.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart showing important and innovative steps in the method of making the woven textile fabric of the invention.

FIG. 2 is a schematic showing the manufacture of warp yarn including the ring spinning step.

FIG. 3 is a schematic showing the manufacture of the weft filament yarn.

FIG. 4 is a schematic showing the weft feeder mechanism, including pick insertion and the loom apparatus.

FIG. 5 shows a weave diagram view and textile edge view of the resulting woven fabric made by the method of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

The invention relates in part to a woven textile tri-blend cotton fabric that possesses characteristics that make it particularly useful as bed linen, although it is not limited to such a use. Characteristics of the fabric include but are not limited to high comfort, good moisture absorption, excellent wicking ability, good antibacterial and antimicrobial properties, an ultra-soft feel, and strong durability.

Many factors contribute to the fabric possessing the characteristics described above. These factors include but are not limited to, the composition of the fibers that constitute the fabric (including the blend of fibers in the warp yarn and the fiber(s) used in the weft yarn), the weave, the warp and the weft count, the fabric thread count, and the method of weaving the fabric.

According to one embodiment of the invention, cotton and a regenerated cellulosic fiber comprise the warp yarn, and a synthetic yarn (e.g., polyester) comprises the weft yarn.

The ratio of cotton to regenerated cellulosic fiber in the warp yarn may vary. In one embodiment of the invention, the ratio is in the range of 85-95% cotton/about 5%-15% regenerated cellulosic fiber. In another embodiment of the invention, the warp yarn blend is about 90% cotton to about 10% regenerated cellulosic fiber.

The characteristics of the fabric are imparted by the combined properties of each type of fiber used. For example, regenerated cellulosic fiber (e.g., lyocell) is characterized by good hygroscopicity, permeability, a soft feel, antibacterial and antimicrobial properties and a deodorizing nature. Regenerated cellulosic fiber also imparts high comfort, moisture absorption and excellent wicking ability to the fabric.

Cotton imparts to the fabric a luxurious, ultra-soft satin feel for comfort. Cotton also adds some degree of durability.

Although a variety of synthetic fibers may be used as the weft yarn, polyester, often the preferred fiber of the weft yarn, adds wrinkle resistance properties to the fabric as well as enhanced durability. In one embodiment, the polyester is of a fine denier (e.g., from 6 denier to 150 denier). The use of small denier fiber in the weft, while a technical challenge in making the fabric, increases the overall comfort and drape of the fabric. The finer yarn formulations also achieve a higher thread count, which increases comfort. The fine polyester filament weft yarn as used in the method of producing the fabric of the invention, helps to control weft breaks when fed into the loom. The method of producing the fabric of the invention relies on single pick insertion, which in turn results in a loom with multiple adjacent parallel yarns drawn from multiple weft yarn packages.

According to one aspect, the woven textile fabric includes from 44 to 300 epi warp yarns and from 24 to 1800 ppi multifilament polyester weft yarns.

In another aspect, the total thread count of the fabric may be from 132 to 2000 thread count, and each multifilament polyester yarn count of the fabric may have from 8 to 108 filaments each.

Furthermore, the weave of the fabric may be a satin weave which makes the fabric have the feel of cotton. In an embodiment of the invention the weave may be a 1/1 plain weave, a 2/1 twill weave, or a 4/1 satin weave, or a derivative or inverse of these same weaves, or any combination of the same. In another embodiment, the fabric of the invention may have a Dobby weave or a Jacquard weave or any combination of the aforementioned weaves.

According to one embodiment of the invention, the woven textile fabric may have the following construction: 60 s cotton/regenerated cellulosic fabric (90/10)×30D Polyester 175×75(3). In this embodiment, the weave may be 4/1 satin, and the fabric may have the following composition: the regenerated cellulosic fiber is present in an amount of about 4% to about 10%, the cotton is present in an amount ranging from about 61% to about 67%, and the polyester is present in an amount ranging from about 26% to about 32%. In another embodiment of the invention, the regenerated cellulosic fiber is present in an amount of about 7%, cotton is present in an amount of about 64%, and polyester is present in an amount of about 29%.

The woven textile fabric of the invention includes both warp yarns and weft yarns. In one embodiment of the invention, the warp count may range from a 2 s count to a 170 s count. The weft count may range from 6 denier to 150 denier.

The fabric construction may range from 44 ends/inch to 300 ends/inch and from 24 picks/inch to 1800 picks/inch.

Depending on the characteristics of the fabric desired, the woven textile fabric of the invention may have cotton in an amount ranging from 51% to 90%; natural fiber in an amount ranging from 5% to 49%; regenerated cellulosic fiber in an amount ranging from about 1% to 48%; and synthetic fiber in an amount ranging from 5% to 48%.

A feature of the invention is that the warp yarns in the woven textile fabric is made of a blend of fibers that includes cotton and at least one fiber other than cotton. With the weft yarn comprising polyester in this embodiment, the woven textile fabric of the invention is made of at least three components (e.g., cotton, a regenerated cellulosic fiber and polyester).

Another feature of the invention is that the weft yarns may include the use of single filament yarns, as well as multi-filament yarns, depending on the required thread count for the final product. This may be achieved in part by varying the cone hardness or the number of cone packages in the weft pre-winders.

The fabric according to one aspect of the invention maintains its after-wash appearance even after 50 wash cycles. This is achieved in part through the special blend of fibers used to make the fabric of the invention as well as the blend ratios.

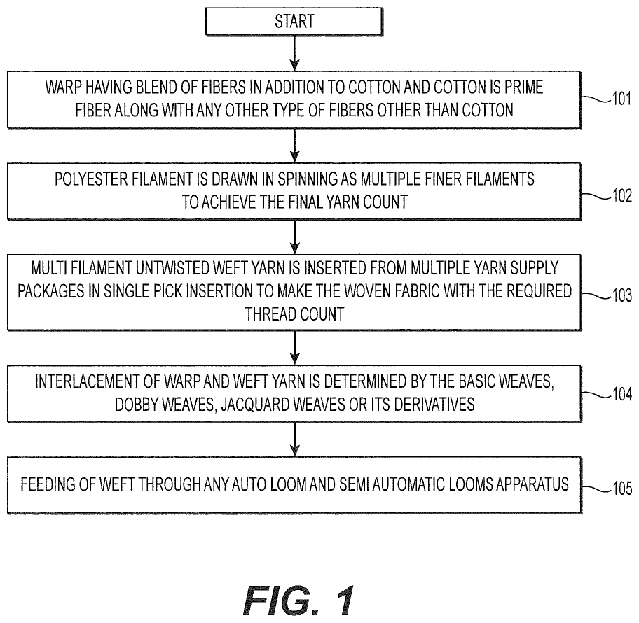

Turning to the drawings, FIG. 1 is a process flow chart showing several important and innovative steps in making the tri-blend cotton fabric of the invention.

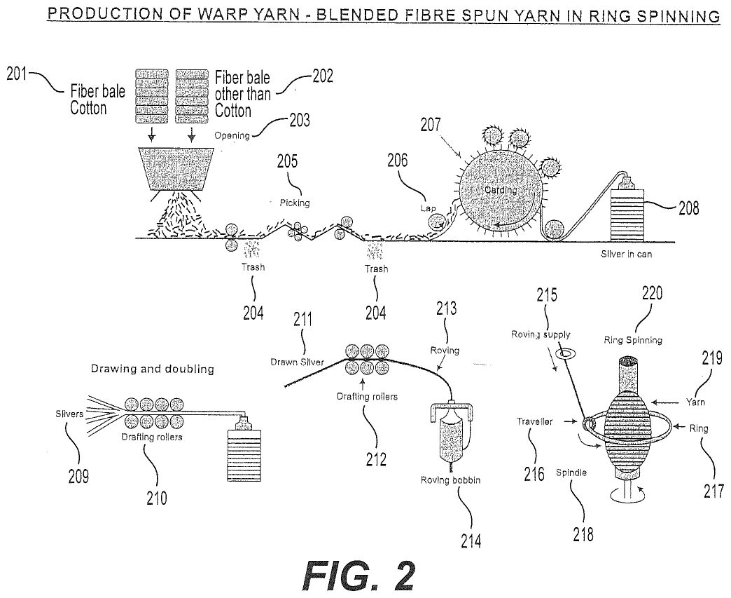

In step 101, the warp yarn is made as a blend of cotton and other fibers, such as any natural, synthetic or manmade fiber (e.g., one or more regenerated cellulosic fibers). Production of the warp yarn is shown in more detail in FIG. 2.

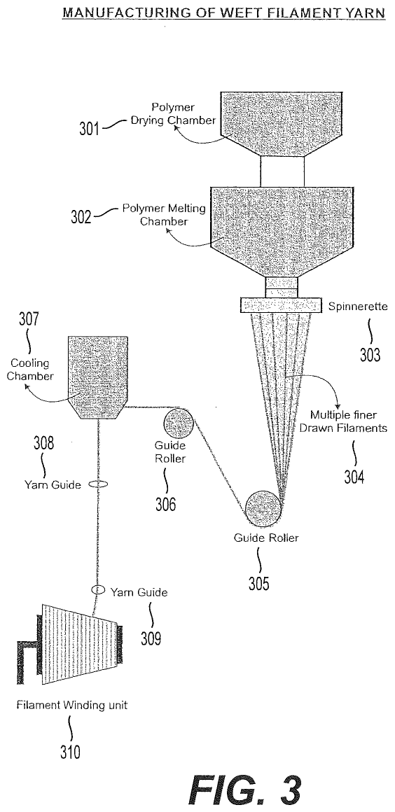

In step 102, the weft yarn is a polyester filament drawn in a spinning step as multiple fine polyester filaments to achieve the appropriate, and typically high, final yarn count as well as other desirable characteristics. Production of the weft yarn is shown in more detail in FIG. 3.

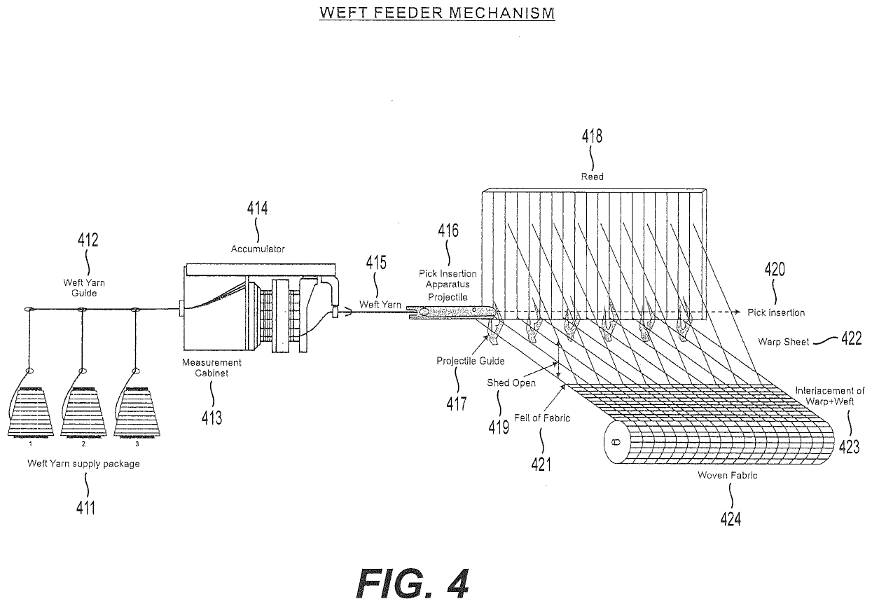

In step 103, multi-filament untwisted weft yarns are drawn from multiple yarn supply packages and interlaced with the warp yarns via single pick insertion to make a woven fabric with the required thread count. Interlacement of the warp and weft yarn 104 is determined by the basic weave of the fabric (e,g., plain weaves, twill weaves, satin weaves, Dobby weaves, Jacquard weaves or combinations, reverses or derivatives of the same) and performed with an automatic or semi-automatic loom apparatus 105. FIG. 4 provides more detail on this aspect of the method.

In FIG. 2, bales of the primary fiber, cotton 201, and at least one other fiber (e.g., a regenerated cellulosic fiber, such as lyocell), are placed in the opening 203 of a hopper and conveyed through a picking stage 205, wherein the fiber is sorted and cleaned. Discarded fiber is thrown in the trash 204. The fiber is then directed through a lap stage 206, in which the cleaned fiber is formed into a sheet form of definite width and uniform unit length. The sheet of fiber is then directed to carding 207 to produce a continuous web or sliver 209 suitable for subsequent processing. After carding the sliver is stored in a series of cans 208.

In the next stage, the slivers 209 are drawn and doubled through drafting rollers 210. The drawn slivers 211 are passed through additional drafting rollers 212 into a roving 213 and wrapped around a roving bobbin 214 prior to further processing. The roving supply 215 then proceeds to a ring spinning stage 220 as it is directed through a traveler 216 and ring 217 via spindle 218 to produce warp yarn 219.

FIG. 3 illustrates the manufacture of the weft yarn. A polymer (e.g., polyethylene) is placed into a polymer drying chamber 301 and, once dried, lowered into a polymer melting chamber 302 wherein the polymer is heated to its melting temperature. The polymer melt is then drawn through a spinneret 303 to extrude multiple finer drawn filaments 304. The filaments then proceed through a series of guide rollers 305 and 306 to a cooling chamber 307 and, once cooled to a sufficient temperature, directed through two yarn guides 308 and 309 to a filament winding unit 310.

FIG. 4 is a schematic of a weft feeder mechanism used to make the fabric of the invention. The weft yarn is stored on a multiple weft yarn supply package 411. The weft yarn is then drawn through a weft yarn guide 412 to a measurement cabinet 413 of an accumulator 414 which holds a length in reserve. The weft yarn 415 may then pass into the pick insertion apparatus projectile 416 wherein air propels single or multiple weft filament yarns through a series of projectile guides 417 across the warp sheet 422 using a loom apparatus.

Upon crossing the warp sheet 422 through an open shed 419, the reed 418 may force the weft yarns into the fell of the fabric 421 produced by the loom apparatus. This forms the warp/weft interlacing of the warp yarns 423 and the weft yarns (e.g., untwisted single or multiple fine texturized filament), producing an incremental length of the woven fabric 424.

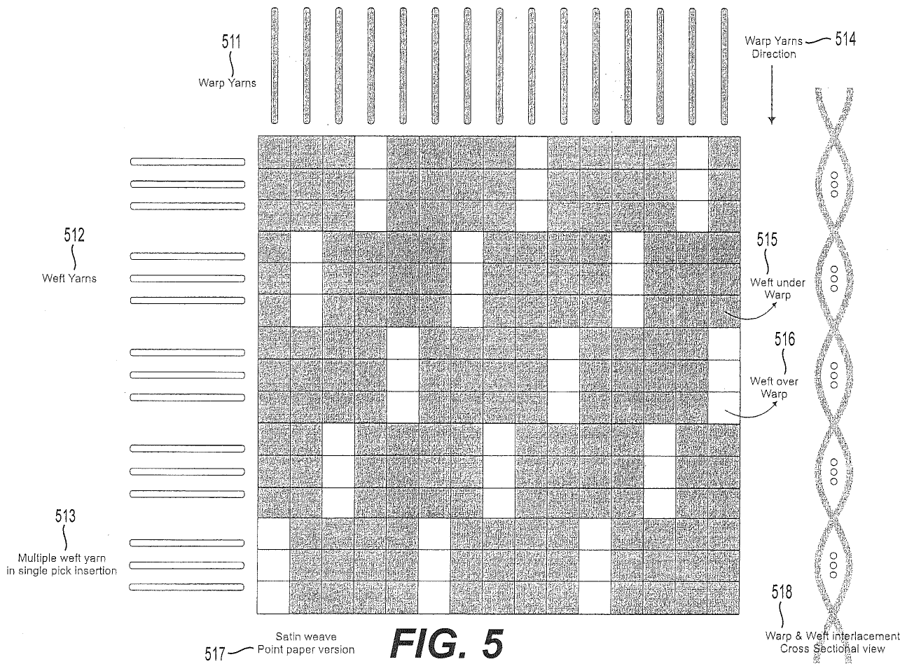

FIG. 5 shows a weave diagram view and textile edge view of the resulting woven fabric made by the method of the invention. The weave is a paper point version of a satin weave 517. In particular, FIG. 5 illustrates a woven textile fabric with sections of weft under warp a 515 and weft over warp 516 in a satin weave. The view also shows the warp yarn direction 514. In this embodiment, multiple weft yarns 513 are interlaced with warp yarns 511.

The warp and weft interlacement cross-sectional view shows the woven fabric from the fabric edge 518. The cross section illustrates the placement of untwisted multiple finer texturized filament yarn inserted between the warp fibers. This insertion was achieved by single pick insertion from multiple weft yarn supply packages and helps to provide the required fabric thread count.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A woven textile fabric comprising warp yarns and weft yarns, wherein the warp yarns comprise cotton and at least one fiber other than cotton, the weft yarns comprise polyester, the fabric comprises from 44 to 300 ends per inch warp yarns and from 24 to 1800 picks per inch weft yarns.

2. The woven textile fabric of claim 1, wherein the at least one fiber other than cotton comprises a regenerated cellulosic fiber.

3. The woven textile fabric of claim 2, wherein the regenerated cellulosic fiber is lyocell.

4. The woven textile fabric of claim 1, wherein the weft yarns comprise untwisted, multiple filament texturized yarns.

5. The woven textile fabric of claim 4, wherein the weft yarns further comprise untwisted, single filament texturized yarn.

6. The woven textile fabric of claim 1, wherein the regenerated cellulosic fiber is present in an amount ranging from about 5% to about 10%, the cotton is present in an amount greater than 51%, and the polyester is present in an amount ranging from about 5% to about 40%.

7. The woven textile fabric of claim 6, wherein the regenerated cellulosic fiber is present in an amount of about 7%, the cotton is present in an amount of about 64%, and the polyester is present in an amount of about 29%.

8. The woven textile fabric of claim 1, wherein the weave is a 1/1 plain weave, a 2/1 twill weave, a 4/1 satin weave, a Dobby weave, a Jacquard weave, any reverse or derivative of the same, or any combination of the same.

9. The woven textile fabric of claim 1, wherein the woven textile fabric is used as bed linen.

10. The woven textile fabric of claim 1, wherein the thread count ranges from about 132 to about 2000.

11. The woven textile fabric of claim 1, wherein the warp count ranges from 2 s count to 170 s count and the weft count ranges from 6 denier to 150 denier.

12. The woven textile fabric of claim 1, wherein the minimum amount of warp yarns in the woven textile fabric is 51% and the maximum amount of weft yarns is 49%.

13. The woven textile fabric of claim 4, wherein the weft yarns comprise multiple filament texturized polyester yarn having from 8 to 108 filaments each.

14. The woven textile fabric of claim 4, wherein the untwisted, multiple filament texturized yarns are inserted into the fabric from multiple weft yarn supply packages in a single pick insertion.

15. The woven textile fabric of claim 14, wherein the untwisted, multiple filament texturized yarns are adjacent.
